(19) United States
(12) Patent Application Publication
(10) Pub. No.: US 2024/0046551 A1
(43) Pub. Date: Feb. 8, 2024

(54) GENERATING GEOMETRY AND TEXTURE FOR VOLUMETRIC VIDEO FROM 2D IMAGES WITH A LIMITED VIEWPOINT

(71) Applicant: YOOM.COM LTD, Ramat Gan (IL)

(72) Inventors: Matan EFRIMA, Tel Aviv (IL); Amir GREEN, Mitzpe Netofa (IL); Vsevolod KAGARLITSKY, Ramat Gan (IL); Michael BIRNBOIM, Holon (IL); Gilad TALMON, Tel Aviv (IL)

(21) Appl. No.: 18/228,127

(22) Filed: Jul. 31, 2023

Related U.S. Application Data
(60) Provisional application No. 63/394,686, filed on Aug. 3, 2022.

(51) Int. Cl. G06T 15/08; G06T 19/20; G06T 3/40

(52) U.S. Cl. CPC G06T 15/08; G06T 19/20; G06T 3/40; G06T 2219/2024; G06T 2219/2016

(57) ABSTRACT

A method for generating a volumetric image of a subject from at least one 2 dimensional image, said at least one 2 dimensional image having a limited number of viewpoints, said volumetric image insertable into an environment.

### CROSS REFERENCE TO RELATED APPLICATIONS

This application claims the benefit of priority of U.S. Provisional Patent Application No. 63/394,686, filed Aug. 3, 2022, the contents of which are all incorporated herein by reference in their entirety.

### FIELD OF THE INVENTION

The present invention generally pertains to a system and method for generating geometry and texture in a 3D video where the 3D video was generated from input images taken from a limited viewpoint.

### BACKGROUND OF THE INVENTION

There is considerable interest in generating 3D video from 2D images. For example, a 3D video could be generated of a person's grandmother waltzing with a famous dancer such as Fred Astaire. Many photographs and movies of Fred Astaire exist so that it would not be difficult to generate a volumetric image of Mr. Astaire in, for example, a white tie and tails, or to generate a 3D video of him dancing a waltz, for any angle or angles desired. However, only a limited number of images of the grandmother exist, almost all of them photographs taken at different times with different clothes on, and with the woman facing (or nearly facing) the camera so that no images were available of her back or the back of her head.

Therefore, in order to generate the desired volumetric video of the woman dancing with Fred Astaire, geometry and texture would have to be generated for portions of her body and clothing where no input images exist.

Typically, in the prior art, generating geometry and texture for the portions of a volumetric image that were not visible in the original image or images created artifacts in the geometry, the texture or both. Artifacts can comprise such things as discontinuities in geometry, texture or both, unexpected changes in geometry, texture or both, or blurring or jaggedness in the image.

It is therefore a long felt need to provide a system and method for generating geometry and texture for volumetric video where 2D images showing a large range of input angles are not available.

### SUMMARY OF THE INVENTION

It is an object of the present invention to disclose a system for generating geometry and texture in a 3D video where the 3D video was generated from input images taken from a limited viewpoint.

It is another object of the present invention to disclose a method for generating a volumetric image of a subject from at least one 2 dimensional image, said at least one 2 dimensional image having a limited number of viewpoints, said volumetric image insertable into an environment, comprising steps of:
acquiring said at least one 2 dimensional image;
generating an initial volumetric image from said at least one 2 dimensional image, said initial volumetric image having a volumetric image front and a volumetric image back, said volumetric image front generated from portions of said subject visible in said at least one 2 dimensional image, said volumetric image back generated from portions of said subject not visible in said at least one 2 dimensional image, said volumetric image front having a higher quality than said volumetric image back; and
reducing the quality of said initial volumetric image, said reducing comprising at least one of the following steps:
   reducing a resolution of the volumetric image front to match a quality of the volumetric image back; or
   changing texture of at least a part of said initial volumetric image;
   simplifying a geometry of said initial volumetric image by changing at least one geometrical feature of said initial volumetric image; or
   simplifying a geometry of said initial volumetric image by reducing resolution of at least one feature of said initial volumetric image; or
   any combination thereof;
thereby generating said volumetric image from said at least one 2 dimensional image.

It is another object of the present invention to disclose the method as described above, additionally comprising a step of providing said texture as a pattern.

It is another object of the present invention to disclose the method as described above, additionally comprising a step of fixing said pattern to a layer on a virtual camera.

It is another object of the present invention to disclose the method as described above, additionally comprising a step of fixing said pattern to said initial volumetric image.

It is another object of the present invention to disclose the method as described above, additionally comprising a step of fixing said pattern to said skeleton.

It is another object of the present invention to disclose the method as described above, additionally comprising a step of fixing said pattern to said center of mass.

It is another object of the present invention to disclose the method as described above, additionally comprising a step of fixing said pattern to a fixed point in space.

It is another object of the present invention to disclose the method as described above, additionally comprising a step of selecting said pattern from a group consisting of a pattern of said environment, a proprietary pattern, a user-selected pattern, or a user-generated pattern.

It is another object of the present invention to disclose the method as described above, additionally comprising a step of providing said pattern either changing over time or fixed over time.

It is another object of the present invention to disclose the method as described above, additionally comprising generating said reducing of said quality by a means comprising a member selected from a group consisting of:
matching a volumetric image geometry style of said initial volumetric image to an environment geometry style of an environment;
reducing said initial volumetric image to a skeleton plus an extent;
reducing said initial volumetric image to a center of mass plus an extent;
applying a pattern to said volumetric image back; and
any combination thereof.

It is another object of the present invention to disclose the method as described above, additionally comprising a step of selecting said higher quality comprising a member of a group consisting of a higher resolution, more detail, fewer artifacts, and any combination thereof.

It is another object of the present invention to disclose the method as described above, additionally comprising a step of selecting said at least a part of said initial volumetric image to be at least a part of said volumetric image back.

It is another object of the present invention to disclose a set of instructions that, when executed, are configured to generate a volumetric image of a subject from at least one 2 dimensional image, said at least one 2 dimensional image having a limited number of viewpoints, said volumetric image insertable into an environment, said instructions comprising steps configured to:
acquire said at least one 2 dimensional image;
generate an initial volumetric image from said at least one 2 dimensional image, said initial volumetric image having a volumetric image front and a volumetric image back, said volumetric image front generated from portions of said subject visible in said at least one 2 dimensional image, said volumetric image back generated from portions of said subject not visible in said at least one 2 dimensional image, said volumetric image front having a higher quality than said volumetric image back; and
reduce the quality of said initial volumetric image, said reducing comprising at least one of the following steps:
   reduce a resolution of the volumetric image front to match a quality of the volumetric image back; or
   change texture of at least a part of said initial volumetric image;
   simplify a geometry of said initial volumetric image by changing at least one geometrical feature of said initial volumetric image; or
   simplify a geometry of said initial volumetric image by reducing resolution of at least one feature of said initial volumetric image; or
   any combination thereof.

It is another object of the present invention to disclose the set of instructions as described above, wherein said texture is provided as a pattern.

It is another object of the present invention to disclose the set of instructions as described above, wherein said pattern is fixed to a layer on a virtual camera.

It is another object of the present invention to disclose the set of instructions as described above, wherein said pattern is fixed to said initial volumetric image.

It is another object of the present invention to disclose the set of instructions as described above, wherein said pattern is fixed to said skeleton.

It is another object of the present invention to disclose the set of instructions as described above, wherein said pattern is fixed to said center of mass.

It is another object of the present invention to disclose the set of instructions as described above, wherein said pattern is fixed to a fixed point in space.

It is another object of the present invention to disclose the set of instructions as described above, wherein said pattern is selected from a group consisting of a pattern of said environment, a proprietary pattern, a user-selected pattern, or a user-generated pattern.

It is another object of the present invention to disclose the set of instructions as described above, wherein said pattern is provided either changing over time or fixed over time.

It is another object of the present invention to disclose the set of instructions as described above, wherein said reducing of said quality is generated by a means comprising a member selected from a group consisting of:
matching a volumetric image geometry style of said initial volumetric image to an environment geometry style of an environment;
reducing said initial volumetric image to a skeleton plus an extent;
reducing said initial volumetric image to a center of mass plus an extent;
applying a pattern to said volumetric image back; and
any combination thereof.

It is another object of the present invention to disclose the set of instructions as described above, wherein said higher quality comprises a member selected from a group consisting of a higher resolution, more detail, fewer artifacts, and any combination thereof.

It is another object of the present invention to disclose the set of instructions as described above, wherein said at least a part of said initial volumetric image is selected to be at least a part of said volumetric image back.

### BRIEF DESCRIPTION OF THE FIGURES

In order to better understand the invention and its implementation in practice, a plurality of embodiments will now be described, by way of non-limiting example only, with reference to the accompanying drawings, wherein

FIGS. 1-4 schematically illustrate a person in an imaginary landscape; and

FIG. 5 depicts a flowchart of an exemplary method of modifying or inserting geometry and texture and modifying resolution.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for generating geometry and texture in a 3D video where the 3D video was generated from input images taken from a limited viewpoint.

The term ‘volumetric image front’ hereinafter refers to the portion(s) of a volumetric image derived from those parts of the subject visible in at least one input 2D image.

The term ‘volumetric image back’ hereinafter refers to the portion(s) of a volumetric image derived from those parts of the subject not visible in any of the input 2D image(s).

The present invention discloses a system and method for generating volumetric video from input images taken from limited viewpoint locations, for example, from a single point of view.

Generating a volumetric image of those portions of a subject that are visible in the input 2D image(s) is well known in the art, as is avoiding having a visible mark where a visible portion from one image abuts a visible portion of another image. Inserting the volumetric image into a background, changing the point of view from which the volumetric image is viewed and changing the positions of features in the volumetric image, such as, but not limited to, moving or bending limbs are also well-known in the art. Therefore, in the prior art, volumetric video of acceptable quality can be generated if the portions of the subject visible in the original 2D image comprise substantially all of the subject.

However, difficulties can arise in generating a volumetric image for portions of the subject that were not visible in the input 2D image(s); artifacts such as mismatches of texture (color, pattern) or geometry between adjacent areas are all too common. In addition, there can be mismatch between higher-resolution portions of the volumetric image and lower-resolution portions of the volumetric image; the higher-resolution portions typically generated from portions of the subject visible in the initial 2D image(s) and the lower-resolution portions typically generated by algorithms as fill-in for the originally-invisible portions of the subject.

There are several methods which can be used to mitigate or hide the such artifacts. Non-limiting examples comprise: reducing the resolution of the volumetric image in the higher-resolution portions thereof, thereby blurring the artifact; simplifying the geometry or the texture by removing detail; or superimposing a predetermined pattern on the lower-resolution portions of the volumetric image. The predetermined pattern can be, for non-limiting example, a simplified version of an existing pattern in the texture; or it can be a pattern or fixed type, for non-limiting example, a proprietary identifier unique to a game or supplier.

It can also be desired to enable customization of the effect that is superimposed on top of the volumetric video.

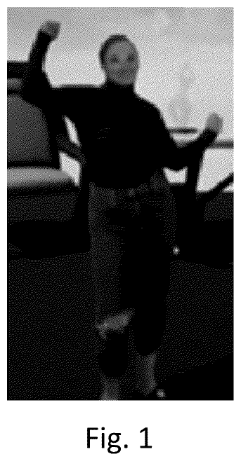

Any or all of the above can be carried out by changing at least one portion of the texture, the geometry or both of the volumetric image to fit a type of “mold”. Non-limiting examples of a change of this kind comprise:
1. Changing the geometry of the volumetric image back (originally not seen) to a volumetric image having a geometry with limited degrees of freedom (see, for example, Roblox Studio, Minecraft customization, etc.).
2. Changing the texture of at least a part of the volumetric image back to incorporate a pattern (alpha blend). The pattern can be chosen so that is does not look natural. For non-limiting example, as shown in FIGS. 1-3, the pattern can comprise a set of circles superimposed on the volumetric image back, with the circles expanding and contracting over time.
3. Reduce the resolution of the volumetric image front to match that of the volumetric image back.

Combinations of the above can also be used. For non-limiting example, changing to a volumetric image having a geometry with limited degrees of freedom and incorporating a pattern on the volumetric image back.

If the texture of the volumetric image back is changed, the user can be given a choice—a texture providing a look and feel characteristic of the environment into which the subject is to be inserted (for non-limiting example, a Minecraft texture, a Roblox Studio texture, etc.), a proprietary texture providing a look and feel characteristic of a supplier (for non-limiting example, the texture shown in FIGS. 1-3), or a user-supplied texture.

These effects can be instituted by:
A. Fixing a texture in space, for modification of a pattern or alteration of the resolution and terminating the texture at the boundary of the subject. If the texture is fixed in space, the texture will shift relative to the volumetric image as the volumetric image moves in the environment. For non-limiting example, let the applied texture, fixed in space, be a grid of vertical arrows. Let the volumetric image, in a first pose, have its arm extended horizontally. In a second pose, let the lower arm and hand be vertical, while the upper arm remains horizontal. If the tail of an arrow in the grid is located at the elbow, only the bottom of that arrow will be seen in the first pose, while the entire arrow will be seen in the second pose. If the texture to be added is carefully chosen, if the volumetric image does not move too much, or if the resolution is low enough, the shifting of the texture relative to the volumetric image will not be obvious.
B. Attaching the texture to the skeleton of the result, for modification of a pattern or alteration of the geometry. Attaching the texture to the skeleton requires more computing power to apply the texture than fixing the texture in space, but will reduce the obviousness of a shift in texture relative to the volumetric image.
C. Attaching the texture to the center of mass of the result for modification of a pattern or alteration of the resolution. Attaching the texture to the center of mass requires more computing power than fixing the texture in space, but less than attaching the texture to the skeleton.

The texture can be moved with the body of the subject, with the camera (by providing a texture layer on the camera and terminating the texture layer at the edges of the subject), or with the environment (by fixing the texture layer to the environment and terminating the texture layer at the edges of the subject).

FIGS. 1-4 show examples of changing geometry, changing viewpoint and changing texture. FIG. 1 shows a human figure in an imaginary landscape, viewed from the direction in which an original image was taken. In the original image (not shown) the figure had her arms bent in an L-shape, with the forearms vertical. In FIG. 1, the viewpoint is approximately the same as in the original image, but the geometry has been changed—the body is leaning to its right, the right arm has been raised and the left arm lowered. No added texture can be seen.

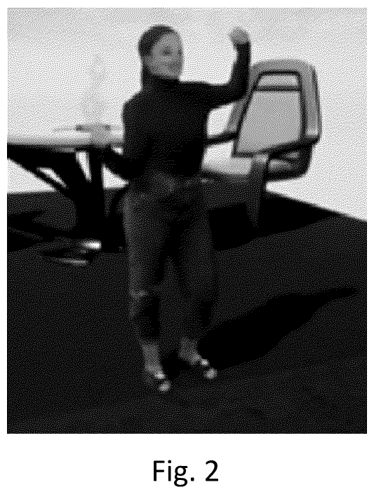

In FIG. 2, the viewpoint has been moved and the body pose further altered but, since the pose is still within the limits of the original images, no added texture can be seen.

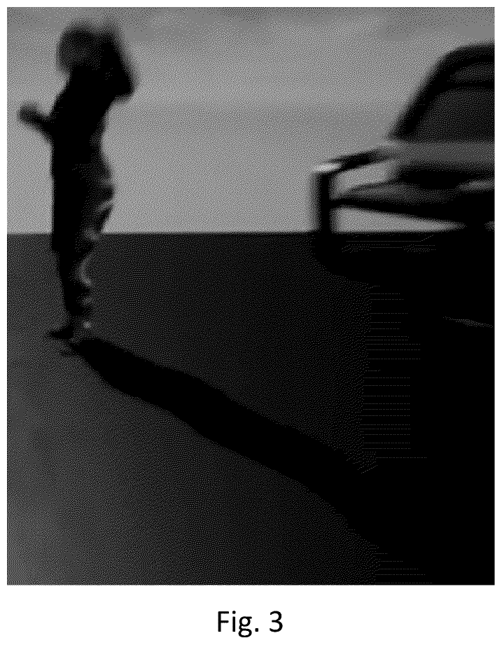

In FIG. 3, the figure is seen from the side. The circles defining the added texture can be seen on the back of the figure. The circles provide a texture that deliberately differs from the texture of the parts of the body visible in the original 2D image.

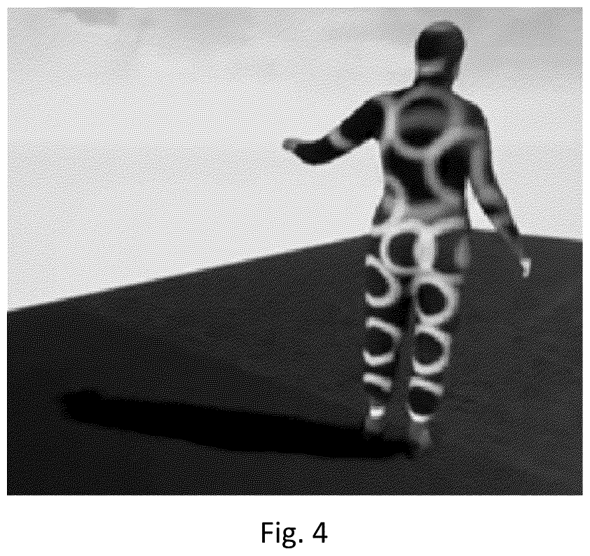

In FIG. 4, the figure is seen from the back. The circles defining the added texture can be seen on the back of the figure. The circles, which change in size over time, provide a texture that deliberately differs from the texture of the parts of the body visible in the original 2D image.

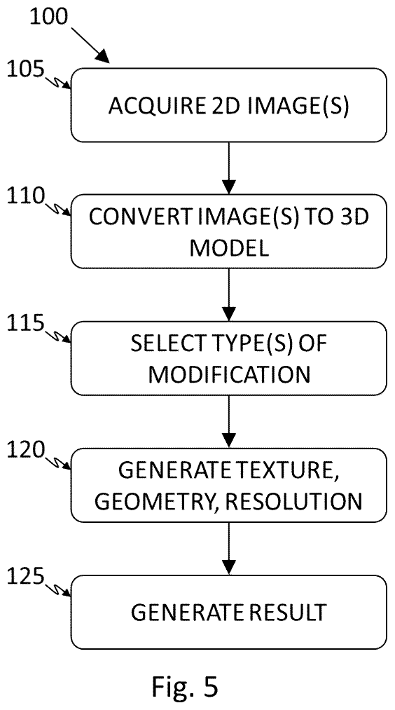

An exemplary method (100) of generating geometry, texture and resolution from at least one 2D image is shown in FIG. 5. At least one 2D image is acquired (105) and converted to a 3D volumetric image (110). This volumetric image may have holes or gaps where it was not possible to determine the geometry and/or texture from the initial 2D image. For non-limiting example, if there is a single 2D input image of the subject, taken from the front of the subject, a gap would encompass the entire back of the subject. Because of limitations in computing power—it takes much more computing power to generate the volumetric image back, where many of the parameters are unknown, than the volumetric image front—the portions of the volumetric image generated from portions of the subject visible in the input image(s) (the volumetric image front) will have a higher quality than the portions of the volumetric image generated from portions of the subject not-visible in the input image(s) (the volumetric image back), where the higher quality comprises at least one of a higher resolution, more detail and fewer artifacts. This can result in the resulting volumetric image having an unacceptable look-and-feel because of the differences in quality between the volumetric image front and the volumetric image back. Furthermore, since many parameters of the volumetric image back are unknown, repositioning parts of the volumetric image relative to each other (for non-limiting example, fingers relative to hand, hand relative to arm, arm relative to body) takes more computing power for the volumetric image back than the volumetric image front, and it can be desired to make these changes “on the fly” so that there are time constraints as well as computing power constraints to be dealt with.

In order to provide a result of acceptable quality, modifications to the volumetric image can be selected (115) to enable reduction of or hiding of the discrepancy between the volumetric image front and the volumetric image back. This can be done by reducing the resolution of the volumetric image front to match that of the volumetric image back, by simplifying the geometry, by attaching a predetermined texture to at least a part of the volumetric image back, or any combination thereof.

Typical types of modification comprise:

The volumetric image geometry can be simplified by combining features, for non-limiting example, by combining the fingers and palm of a hand into a single block, by reducing the number of joints in the volumetric image, or by treating the volumetric image, for the purpose of adding texture, as a center of mass. Simplifying the geometry can also reduce or eliminate the discrepancy in resolution. The type of simplification can match the subject to the environment into which the subject is inserted. For non-limiting example, a subject to be inserted into a Minecraft environment would be reduced to a head, a torso, two arms, two legs and, sometimes, a neck, each of these being a cuboid. These blocks can move relative to each other. The blocks have appropriate texture; for example, the head block comprises eyes, ears, nose, mouth and hair.

Another type of simplification, which also reduces or eliminates the discrepancy in resolution, reduces the subject to a skeleton with an extent; in yet another type of simplification, the subject is reduced to a center of mass with an extent.

Simplification can also comprise reducing the complexity of features, joining features to other feature, or eliminating features. Features of this type can comprise clothing, wrinkles in clothing, belts, buckles, or fasteners (buttons, ties, snaps, etc.). For non-limiting example, a shirt, waistcoat and jacket could be combined into a single, wrinkle-free unit forming a colored layer integral with the body.

A pattern can be superimposed on the volumetric image back, to hide the discrepancy in resolution.

The pattern can be selected to match the types of pattern in the environment, it can be a proprietary pattern (such as the enlarging and shrinking circles of FIGS. 1-4), or it can be a user-selected or user-generated pattern. The pattern can remain constant over time, or it can change over time (for non-limiting example, adding a property, changing the size of a property, changing the color of a property, changing the shape of a property, changing the number of properties, or any combination thereof), where a set of properties defines the pattern. A property can comprise a color, a size, a shape, or any combination thereof. A relationship between properties can also be changed.

The superimposition can be relative to the camera (e.g., a pattern layer at the virtual location of the camera, the pattern layer “trimmed” frame-by-frame to match the 2D shape and size of the subject as seen by the camera. The superimposition can be relative to a skeleton of the volumetric image, relative to the volumetric image, relative to a center of mass of the volumetric image, or relative to a fixed point in the space of the environment.

Another type of simplification reduces the resolution of the volumetric image front to match that of the volumetric image back, thus eliminating the discrepancy in resolution. This is the easiest simplification, but it can be problematic, in that it can result in a subject who appears blurred relative to a sharper environment.

Once the type(s) of modification have been selected (115), they are applied (120) to the volumetric image, generating (125), frame-by-frame, a result showing the subject in the environment, the subject having an acceptable, although not necessarily realistic, look-and-feel.

1. A method for generating a volumetric image of a subject from at least one 2 dimensional image, said at least one 2 dimensional image having a limited number of viewpoints, said volumetric image insertable into an environment, comprising steps of:
acquiring said at least one 2 dimensional image;
generating an initial volumetric image from said at least one 2 dimensional image, said initial volumetric image having a volumetric image front and a volumetric image back, said volumetric image front generated from portions of said subject visible in said at least one 2 dimensional image, said volumetric image back generated from portions of said subject not visible in said at least one 2 dimensional image, said volumetric image front having a higher quality than said volumetric image back; and
reducing the quality of said initial volumetric image, said reducing comprising at least one of the following steps:
reducing a resolution of the volumetric image front to match a quality of the volumetric image back;
changing texture of at least a part of said initial volumetric image;
simplifying a geometry of said initial volumetric image by changing at least one geometrical feature of said initial volumetric image;
simplifying a geometry of said initial volumetric image by reducing resolution of at least one feature of said initial volumetric image; or
any combination thereof;
thereby generating said volumetric image from said at least one 2 dimensional image.

2. The method of claim 1, additionally comprising a step of providing said texture as a pattern.

3. The method of claim 2, additionally comprising a step of fixing said pattern, said fixing selected from a group consisting of fixing said pattern to a layer on a virtual camera, fixing said pattern to said initial volumetric image, fixing said pattern to said skeleton, fixing said pattern to said center of mass, or fixing said pattern to a fixed point in space.

4. The method of claim 1, additionally comprising a step of selecting said pattern from a group consisting of a pattern of said environment, a proprietary pattern, a user-selected pattern, or a user-generated pattern.

5. The method of claim 1, additionally comprising a step of providing said pattern either changing over time or fixed over time.

6. The method of claim 1, additionally comprising generating said reducing of said quality by a means comprising a member selected from a group consisting of:
matching a volumetric image geometry style of said initial volumetric image to an environment geometry style of an environment;
reducing said initial volumetric image to a skeleton plus an extent;
reducing said initial volumetric image to a center of mass plus an extent;
applying a pattern to said volumetric image back; and
any combination thereof.

7. The method of claim 1, additionally comprising a step of selecting said higher quality comprising a member of a group consisting of a higher resolution, more detail, fewer artifacts, and any combination thereof.

8. The method of claim 1, additionally comprising a step of selecting said at least a part of said initial volumetric image to be at least a part of said volumetric image back.

9. A set of instructions that, when executed, are configured to generate a volumetric image of a subject from at least one 2 dimensional image, said at least one 2 dimensional image having a limited number of viewpoints, said volumetric image insertable into an environment, said instructions comprising steps configured to:
acquire said at least one 2 dimensional image;
generate an initial volumetric image from said at least one 2 dimensional image, said initial volumetric image having a volumetric image front and a volumetric image back, said volumetric image front generated from portions of said subject visible in said at least one 2 dimensional image, said volumetric image back generated from portions of said subject not visible in said at least one 2 dimensional image, said volumetric image front having a higher quality than said volumetric image back; and
reduce the quality of said initial volumetric image, said reducing comprising at least one of the following steps:
reduce a resolution of the volumetric image front to match a quality of the volumetric image back;
change texture of at least a part of said initial volumetric image;
simplify a geometry of said initial volumetric image by changing at least one geometrical feature of said initial volumetric image;
simplify a geometry of said initial volumetric image by reducing resolution of at least one feature of said initial volumetric image; or
any combination thereof.

10. The set of instructions of claim 9, wherein said texture is provided as a pattern.

11. The set of instructions of claim 10, wherein said pattern is fixed, said fixing selected from a group consisting of fixed to a layer on a virtual camera, fixed to said initial volumetric image, fixed to said skeleton, fixed to said center of mass, or fixed to a fixed point in space.

12. The set of instructions of claim 9, wherein said pattern is selected from a group consisting of a pattern of said environment, a proprietary pattern, a user-selected pattern, or a user-generated pattern.

13. The set of instructions of claim 9, wherein said pattern is provided either changing over time or fixed over time.

14. The set of instructions of claim 9, wherein said reducing of said quality is generated by a means comprising a member selected from a group consisting of:
matching a volumetric image geometry style of said initial volumetric image to an environment geometry style of an environment;
reducing said initial volumetric image to a skeleton plus an extent;
reducing said initial volumetric image to a center of mass plus an extent;
applying a pattern to said volumetric image back; and
any combination thereof.

15. The set of instructions of claim 9, wherein said higher quality comprises a member selected from a group consisting of a higher resolution, more detail, fewer artifacts, and any combination thereof.

16. The set of instructions of claim 9, wherein said at least a part of said initial volumetric image is selected to be at least a part of said volumetric image back.
